(19) United States
(12) Patent Application Publication
(10) Pub. No.: US 2023/0422316 A1
(43) Pub. Date: Dec. 28, 2023

(54) METHODS AND PROCEDURE FOR NSTR START TIME SYNCHRONIZATION

(71) Applicant: Samsung Electronics Co., Ltd., Suwon-si (KR)

(72) Inventors: Peshal Nayak, Plano, TX (US); Rubayet Shafin, Allen, TX (US); Boon Loong Ng, Plano, TX (US); Vishnu Vardhan Ratnam, Plano, TX (US)

(21) Appl. No.: 18/339,161

(22) Filed: Jun. 21, 2023

Related U.S. Application Data
(60) Provisional application No. 63/356,363, filed on Jun. 28, 2022.
(60) Provisional application No. 63/358,027, filed on Jul. 1, 2022.

(51) Int. Cl. H04W 74/08

(52) U.S. Cl. CPC H04W 74/085; H04W 74/0866

(57) ABSTRACT

Methods and apparatuses for non-simultaneous transmit/receive (NSTR) start time synchronization are disclosed. A method for wireless communication performed by a non-access point (AP) multi-link device (MLD) that comprises stations (STAs), the method comprising: forming links with corresponding APs of an AP MLD; detecting a non-simultaneous transmit and receive (NSTR) link pairs; detecting an attempt by a first STA of the NSTR link pairs to synchronize start times of physical layer protocol data units (PPDUs) with a second STA of the NSTR link pairs, wherein the first STA is configured to hold a backoff counter at a value of zero during a backoff hold time duration; determining the backoff hold time duration; and determining a number of time intervals that can fit into the backoff hold time duration.

### CROSS-REFERENCE TO RELATED APPLICATION AND CLAIM OF PRIORITY

This application claims priority under 35 U.S.C. § 119(e) to U.S. Provisional Patent Application No. 63/356,363 filed on Jun. 28, 2022, and U.S. Provisional Patent Application No. 63/358,027 filed on Jul. 1, 2022, which are hereby incorporated by reference in their entirety.

### TECHNICAL FIELD

This disclosure relates generally to transmission efficiency in wireless communications systems that include multi-link devices. Embodiments of this disclosure relate to methods and apparatuses for non-simultaneous transmit/receive (NSTR) start time synchronization.

### BACKGROUND

Wireless local area network (WLAN) technology allows devices to access the internet in the 2.4 GHz, 5GHz, 6GHz, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Multi-link operation (MLO) is a feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-access point (AP) multi-link device (MLD) to discover, authenticate, associate, and set up multiple links with an AP MLD. Channel access and frame exchange is possible on each link between the AP MLD and non-AP MLD.

### SUMMARY

Embodiments of the present disclosure provide methods and apparatuses for NSTR start time synchronization.

In one embodiment, a non-access point (AP) multi-link device (MLD) is provided, comprising: stations (STAs) each comprising a transceiver configured to form a link with a corresponding AP of an AP MLD. The non-AP MLD further comprises a processor operably coupled to the STAs, the processor configured to: detect a non-simultaneous transmit and receive (NSTR) link pairs; detect an attempt by a first STA of the NSTR link pairs to synchronize start times of physical layer protocol data units (PPDUs) with a second STA of the NSTR link pairs, wherein the first STA is configured to hold a backoff counter at a value of zero during a backoff hold time duration; determine the backoff hold time duration; and determine a number of time intervals that can fit into the backoff hold time duration.

In another embodiment, a method for wireless communication performed by a non-access point (AP) multi-link device (MLD) that comprises stations (STAs), the method comprising: forming links with corresponding APs of an AP MLD; detecting a non-simultaneous transmit and receive (NSTR) link pairs; detecting an attempt by a first STA of the NSTR link pairs to synchronize start times of physical layer protocol data units (PPDUs) with a second STA of the NSTR link pairs, wherein the first STA is configured to hold a backoff counter at a value of zero during a backoff hold time duration; determining the backoff hold time duration; and determining a number of time intervals that can fit into the backoff hold time duration.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example AP according to embodiments of the present disclosure;

FIG. 2B illustrates an example station (STA) according to embodiments of the present disclosure;

FIG. 3 illustrates an example of NSTR mobile AP MLD operation according to various embodiments of this disclosure;

FIG. 4 illustrates an example of NSTR operation with start time sync PPDU access procedure according to various embodiments of this disclosure;

FIG. 5 illustrates an example with reception occurrence during backoff hold time according to various embodiments of this disclosure;

FIG. 6 illustrates an example timeline showing various detection occurring after reception start time according to various embodiments of this disclosure;

FIG. 7 illustrates a flowchart of a method performed by an AP for medium synchronization recovery based on timing constraint information according to embodiments of the present disclosure;

FIG. 8 illustrates a modified structure of an AAR control subfield according to embodiments of the present disclosure;

FIG. 9 illustrates a timing diagram for use of the modified structure of the AAR control subfield according to embodiments of the present disclosure;

FIG. 10 illustrates a flowchart of a method for NSTR start time synchronization according to embodiments of the present disclosure;

FIG. 11 illustrates a flowchart of a method for slotted backoff hold time computation according to embodiments of the present disclosure;

FIG. 12 illustrates an example frame format for request frame for collection of backoff hold time slot duration from the non-AP MLDs by the AP MLD according to embodiments of the present disclosure;

FIG. 13 illustrates an example Link ID element for the request frame format according to embodiments of the present disclosure;

FIG. 14 illustrates an example frame format for a response frame transmitted by the non-AP MLD to the APMLD according to embodiments of the present disclosure;

FIG. 15 illustrates an example backoff hold time slot duration element frame format according to embodiments of the present disclosure;

FIG. 16 illustrates an example of a slotted backoff hold time procedure according to embodiments of the present disclosure; and

FIG. 17 illustrates a flowchart of a method for wireless communication performed by a non-AP device according to embodiments of the present disclosure.

### DETAILED DESCRIPTION

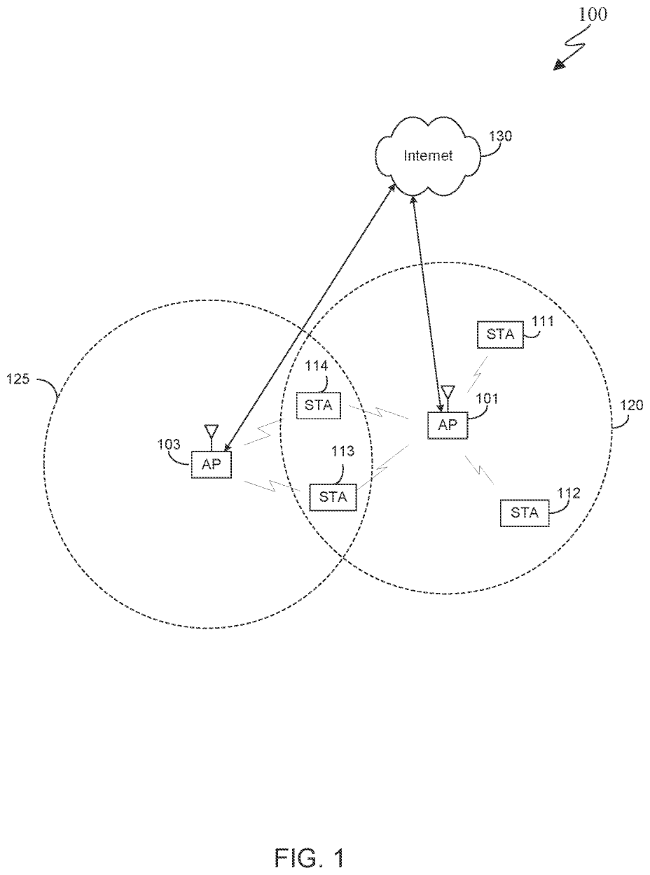

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: IEEE P802.11be/D3.0, 2023 (herein REF [1]).

Embodiments of the present disclosure provide mechanisms for traffic urgency indication.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for traffic urgency indication. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

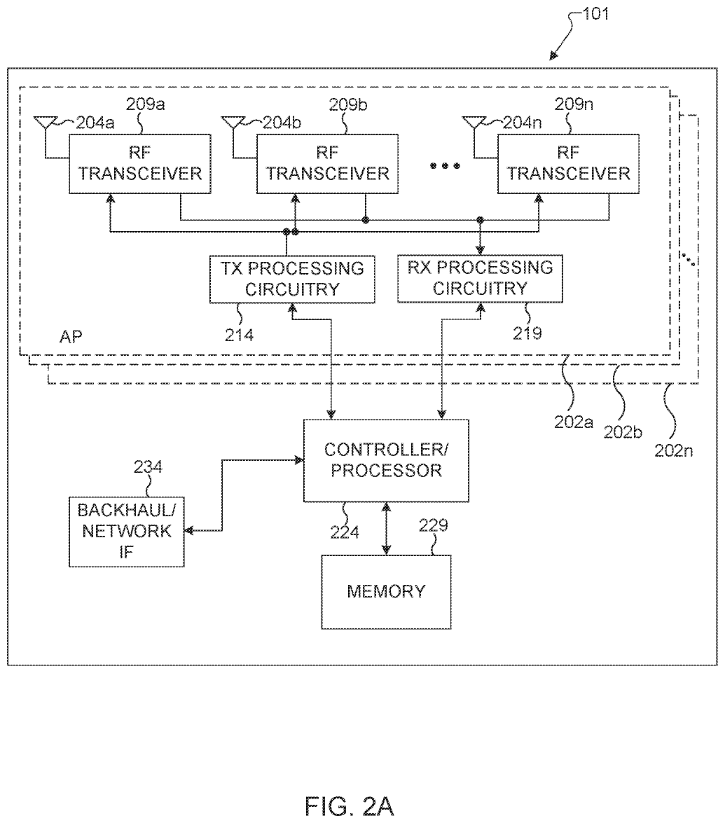

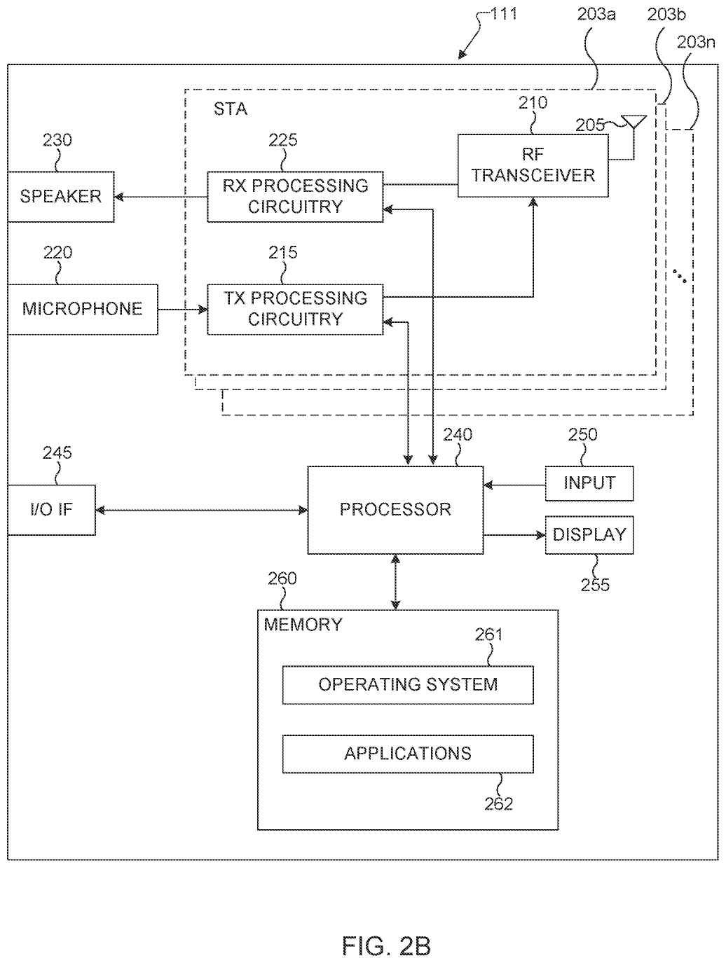

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224 including traffic urgency indication. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for traffic urgency indication. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives, from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to support traffic urgency indication. In some embodiments, the controller/processor 240 includes at least one microprocessor or microcontroller.

The controller/processor 240 is also capable of executing other processes and programs resident in the memory 260, such as operations for supporting traffic urgency indication. The controller/processor 240 can move data into or out of the memory 260 as required by an executing process. In some embodiments, the controller/processor 240 is configured to execute a plurality of applications 262, such as applications for supporting traffic urgency indication. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Various embodiments of the present disclosure recognize that multi-link operation has two key variants. The first variant is STR (simultaneous transmit/receive) in which the STAs affiliated with a MLD can transmit and receive independent of each other. The second variant is NSTR (non-simultaneous transmit/receive). If a pair of links constitute an NSTR pair, then transmission on one link can cause a signal leakage which interferes with the reception of the other link. Due to this interference, the device cannot transmit on one link while receiving on the other. The NSTR capability of a device can vary over time depending on a number of factors such as the frequency separation between the links, antenna separation, chip's internal design, etc. Consequently, non-AP STAs are more likely to be NSTR constrained. As a result, a realistic performance upper-bound of multi-link operation in 802.11be will be achieved in a scenario which comprises STR APs affiliated with an AP MLD connected to NSTR non-AP STAs affiliated with a non-AP MLD. In order to avoid the interference arising from signal leakage under NSTR constraints, the standard requires the start and end times on the links that constitute an NSTR link pair to be aligned. With such an alignment, two links that constitute an NSTR link pair are either both in transmit mode or both in reception mode. Consequently, there is no impact of signal leakage from one link to the other and both links can be used simultaneously to achieve higher throughput values envisioned by 802.11be.

Various embodiments of the present disclosure recognize that in NSTR mode of operation when one of the STAs that constitutes an NSTR link pair transmits a frame and the other STA affiliated with the same MLD is not able to start transmission, the other STA faces blindness due to which the STA may not be able to sense preambles of other transmissions on its channel and may need to start a medium synchronization loss recovery procedure. One of the procedures described in REF [1] leverages an AP assisted medium synchronization recovery to help the non-AP STA affiliated with a non-AP MLD that has lost synchronization to transmit a frame without causing collision with an existing transmission on its own channel.

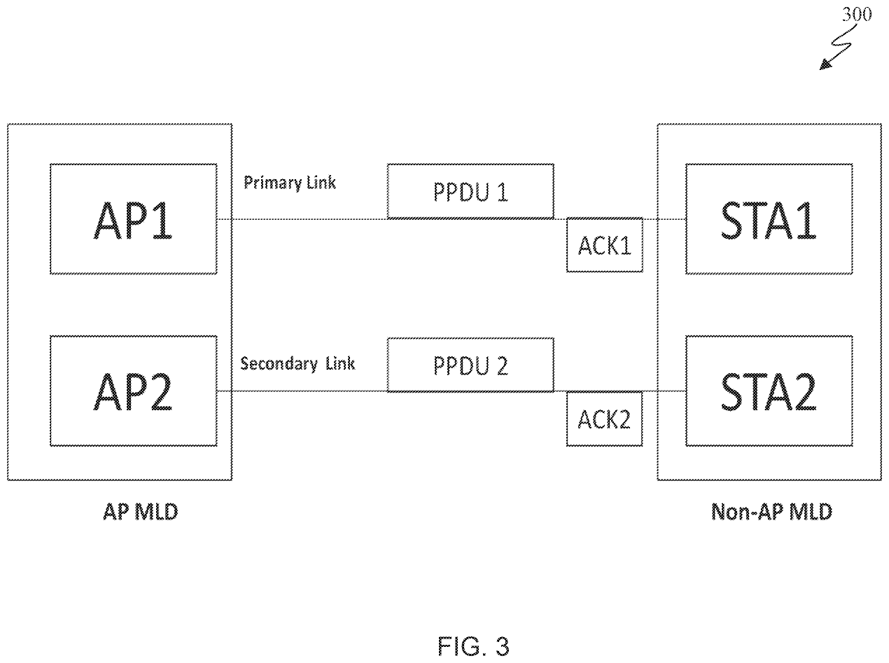

FIG. 3 illustrates an example of NSTR mobile AP MLD operation 300 according to various embodiments of this disclosure. The embodiment of the example NSTR mobile AP MLD operation 300 shown in FIG. 3 is for illustration only. Other embodiments of the example NSTR mobile AP MLD operation 300 could be used without departing from the scope of this disclosure.

As depicted in FIG. 3, two APs namely AP1 and AP2 are affiliated with a NSTR Mobile AP MLD. Further, STA1 and STA2 are two non-AP STAs affiliated with a non-AP MLD. STA1 and STA2 are associated with AP1 and AP2 respectively resulting in two links. The link between AP1 and STA1 is designated as the primary link and the link between AP2 and STA2 is designated as the non-primary link.

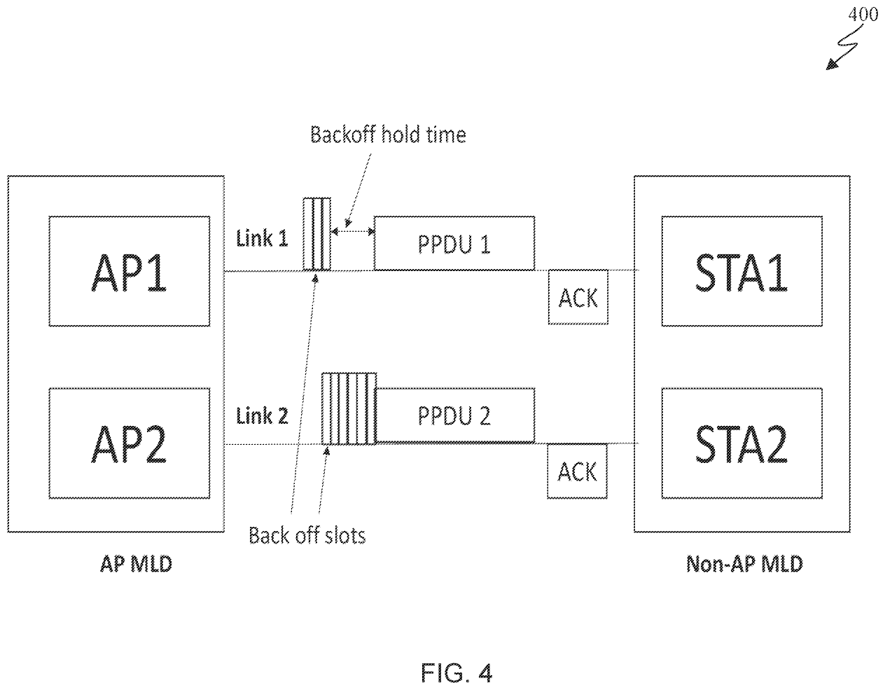

FIG. 4 illustrates an example of NSTR operation with start time sync PPDU access procedure 400 according to various embodiments of this disclosure. The embodiment of the example NSTR operation with start time sync PPDU access procedure 400 shown in FIG. 4 is for illustration only. Other embodiments of the example NSTR operation with start time sync PPDU access procedure 400 could be used without departing from the scope of this disclosure.

According to 802.11 random backoff procedure for channel access, the STA that has data for transmission generates a random backoff count. The backoff count is a pseudorandom integer drawn from a uniform distribution over the range [0, CW] where aCWmin≤CW≤aCWmax. CW starts with an initial value of aCWmin and with each failed transmission attempt, its value is increased exponentially until it reaches aCWmax. When the backoff count is chosen, the STA counts for those many number of backoff slots. Each backoff slot has a fixed duration that is determined by the spec (e.g., 9 microseconds in 802.11ac and higher standards). After the number of slots remaining becomes zero, the device can initiate a transmission.

In order to synchronize the start times of transmission, the IEEE 802.11be provides a start time sync PPDU access procedure. As a part of this procedure, when the backoff counter of an STA of an MLD that is a part of an NSTR link pair reaches zero, the STA can choose not to transmit and keep its backoff counter at zero to synchronize the start time with the other link that constitutes an NSTR link pair.

An example is as shown in FIG. 4. As depicted, a non-AP MLD forms two links—link 1 and link 2 after association with an AP MLD. The AP MLD has two APs—AP 1 and AP 2 affiliated with it. The non-AP MLD has two non-AP STAs—STA1 and STA2 affiliated with it. The STAs of the non-AP MLD have data packets to transmit to the AP MLD. Each STA starts a backoff procedure as shown in the figure. When STA1 affiliated with the non-AP MLD counts to zero, it may want to hold the counter at zero for an amount of time hereby referred to as backoff hold time to synchronize with STA2 affiliated with the same non-AP MLD (an example of which is shown in FIG. 4). Following the backoff hold time, STA1 and STA2 can start their transmission with their PPDU start times synchronized with each other. To allow some tolerance in the alignment of the start times, IEEE 802.11be allows the start times to be misaligned by up to 4 microseconds when the STAs attempt to synchronize them.

Various embodiments of the present disclosure recognize that when one STA affiliated with an MLD attempts to synchronize the start times with the other STA of the same MLD, problems may arise as described below.

For example, when a STA requests for AP assistance in medium synchronization, the AP does not have knowledge of the time limit within which the STA needs to be served. In such a case, the AP may end up serving STAs that no longer need the AP's assistance (e.g., the STA has dropped the packet that it intended to transmit and does not need help anymore from the AP). In such a case, the AP needs to have such knowledge beforehand so that it can take action accordingly.

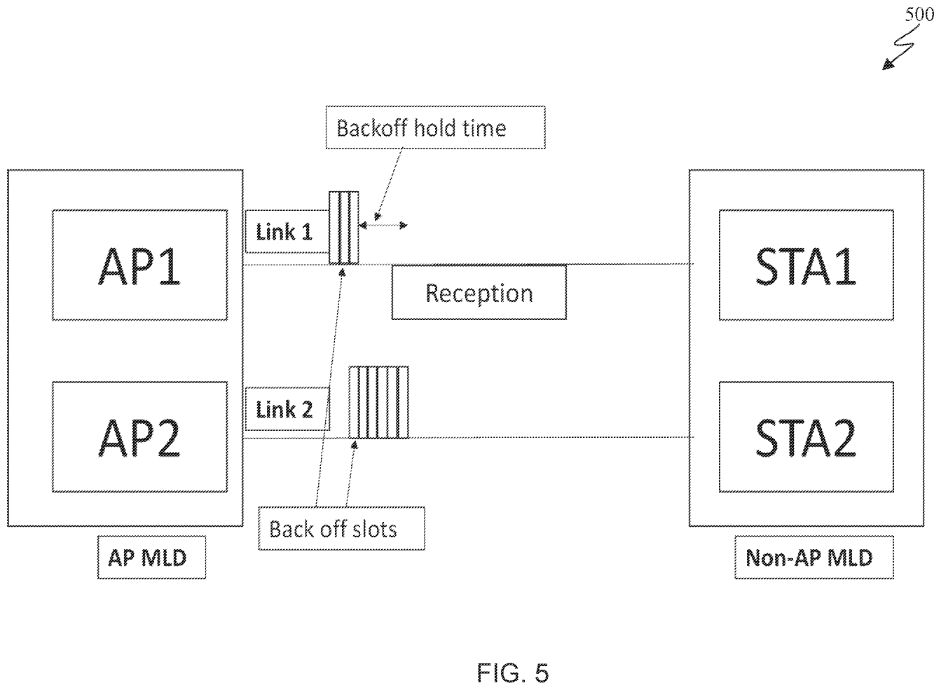

As another example, the device attempting to synchronize the start time holds its backoff counter at zero during the backoff hold time. During this interval, it is possible that the STA that attempts to hold its backoff counter at zero receives a PPDU. An example is shown in FIG. 5, which illustrates an example with reception occurrence during backoff hold time 500 according to various embodiments of this disclosure. The embodiment of the example with reception occurrence during backoff hold time 500 shown in FIG. 5 is for illustration only. Other embodiments of the example with reception occurrence during backoff hold time 500 could be used without departing from the scope of this disclosure.

As illustrated in FIG. 5, STA1 affiliated with a non-AP MLD holds its backoff counter at zero to attempt a start time synchronization with STA2. During this time, STA1 can receive a PPDU on link 1.

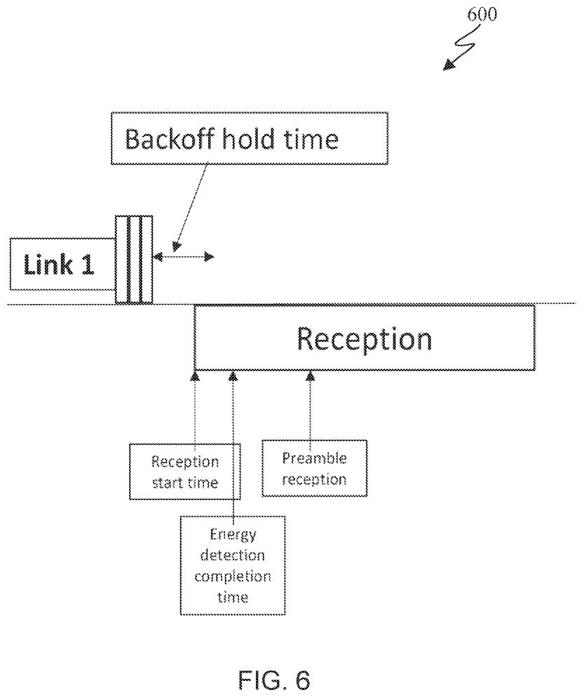

FIG. 6 illustrates an example timeline 600 showing various detection occurring after reception start time according to various embodiments of this disclosure. The embodiment of the example timeline 600 showing various detection occurring after reception start time shown in FIG. 6 is for illustration only. Other embodiments of the example timeline 600 showing various detection occurring after reception start time could be used without departing from the scope of this disclosure.

As shown in FIG. 6, after packet reception starts, there is a finite amount of time after which energy detection is able to detect reception. Typically, energy detection occurs prior to the point where preamble reception is complete and PPDU timing information becomes available.

If reception start occurs during the backoff hold time then it is possible that before energy detection detects a packet on the air, the backoff hold time reaches zero. This could cause the STA1 on link 1 to not accurately detect its own MAC state and initiate a transmission when in fact it has already started to receive a PPDU. This can cause channel collisions to occur which can affect the performance of an NSTR constrained device.

To elaborate, consider the example in FIG. 6, where the STA on link 1 has a packet to transmit and in order to transmit the packet, it is performing a channel contention procedure. After it's backoff counts to 0, it is possible that the STA can hold the backoff counter at 0 to align its start time of transmission with the STA on link 2 (as depicted in FIG. 4). However, as the STA is holding its backoff counter at 0, it is possible that some other device can capture the channel and a packet reception can start. After a packet reception starts, it can take a finite amount of time for the STA to detect that a packet reception has started (as shown in FIG. 6). This amount of time includes primarily time to receive the initial preamble portions fully, perform energy detection to detect a packet on the channel, etc. However, if the backoff hold time can complete after reception starts but before the energy detection is complete, the STA on link 1 can be receiving a frame (but not detected by the STA as energy detection is not completed) and can also begin transmission. This can lead to collisions on the channel as two STAs (STA1 that starts to transmit and the other STA whose is already transmitting on the channel and whose packet is being received by STA1) perform transmissions at the same time. This can degrade the device throughput and performance.

Accordingly, various embodiments of the present disclosure provide mechanisms and frameworks for enabling an AP to have timing constraint information that indicates to the AP the time limit within which the STA needs to be served. In addition, various embodiments of the present disclosure provide mechanisms that a STA can use to accurately detect its own MAC state and initiate a transmission when in fact it has already started to receive a PPDU.

The aforementioned mechanisms and frameworks can help prevent an increase in collisions on the wireless channel which can degrade the performance of an NSTR constrained device

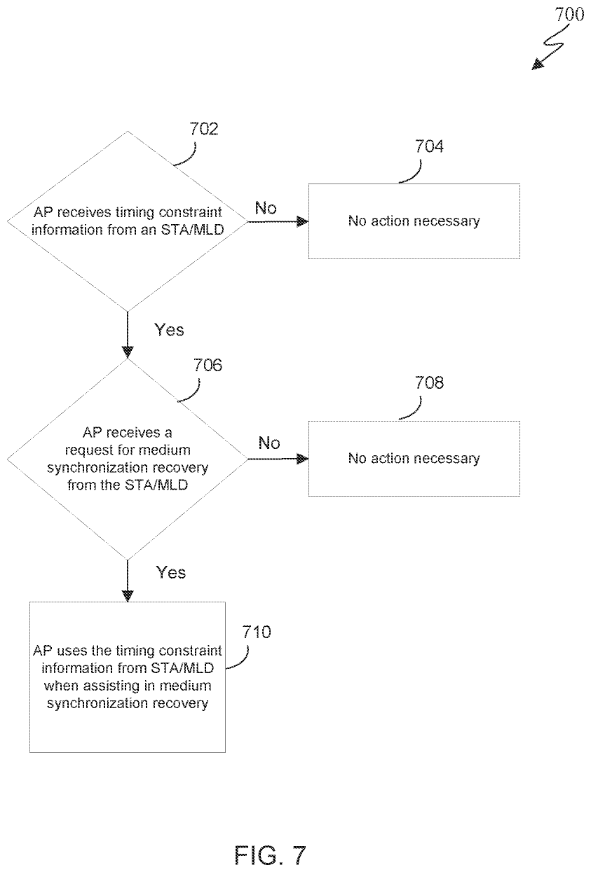

FIG. 7 illustrates a flowchart of an example method 700 performed by an AP for medium synchronization recovery based on timing constraint information according to embodiments of the present disclosure. The embodiment of the method 700 performed by an AP for medium synchronization recovery based on timing constraint information shown in FIG. 7 is for illustration only. Other embodiments of the example method 700 performed by an AP for medium synchronization recovery based on timing constraint information could be used without departing from the scope of this disclosure.

According to one embodiment, the STA that needs the AP's assistance can provide timing constraint information. In one embodiment, the timing constraint information can be provided in the AAR control subfield. This timing constraint can indicate the time until which the STA will need the AP's assistance in order to transmit the corresponding packet. If the AP cannot provide assistance to the STA within this duration, the AP can consider that the STA no longer needs its assistance. The AP can consider a number of factors when determining if it can provide assistance to the STA or not (e.g., average channel access time on the link on which assistance is requested and if it can provide assistance considering the timing constraint of the STA).

As illustrated in FIG. 7, the method 700 begins at step 702, where a determination is made whether an AP receives timing constraint information from an STA/MLD. If not, then at step 704 no action is necessary. If yes, then at step 706, a determination is made whether the AP receives a request for medium synchronization recovery from the STA/MLD. If not, then at step 708, no action is necessary. If yes, then at step 710, the AP uses the timing constraint information from the STA/MLD when assisting in medium synchronization recovery.

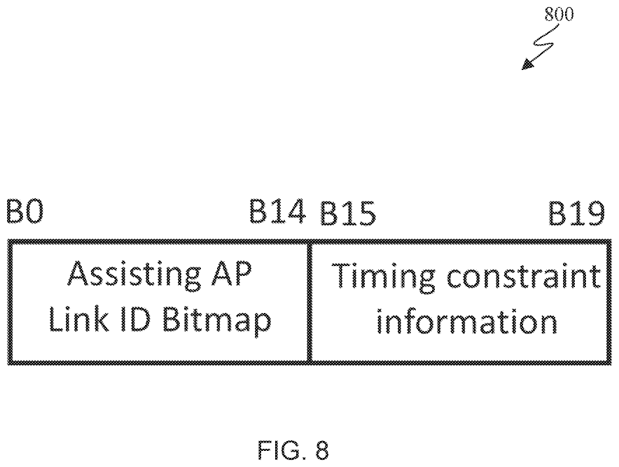

FIG. 8 illustrates a modified structure of an AAR control subfield 800 according to embodiments of the present disclosure. The embodiment of the modified structure of an AAR control subfield 800 shown in FIG. 8 is for illustration only. Other embodiments of the modified structure of an AAR control subfield 800 could be used without departing from the scope of this disclosure.

As illustrated in FIG. 8, the frame structure makes use of the reserved bits (B15-B19) for indicating the timing constraint information. The timing constraint information can be an indicator of the remaining time until which the STA will need the AP's assistance. For example, the remaining packet delay timer value, expiration time for the packet, etc.

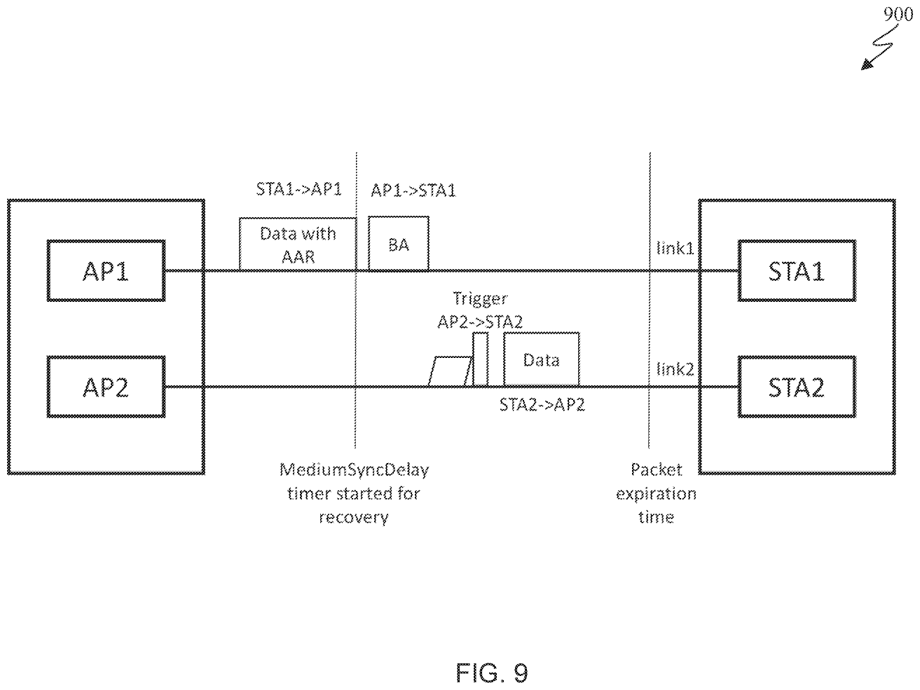

FIG. 9 illustrates a timing diagram 900 for use of the modified structure of the AAR control subfield according to embodiments of the present disclosure. The embodiment of the timing diagram 900 for use of the modified structure of the AAR control subfield shown in FIG. 9 is for illustration only. Other embodiments of the timing diagram 900 for use of the modified structure of the AAR control subfield could be used without departing from the scope of this disclosure.

In another embodiment, for each request the STA makes for AP assistance, the STA can provide a duration until which its request will be considered valid. This can be done by providing a validity period in the AAR control subfield that the STA transmits. Upon expiration of this period, the STA can make another request if necessary and the AP can consider the previous request to be invalid. The duration can be provided relative to the time the STA sends the request.

A timing diagram is as shown in FIG. 9. In this example, the AP MLD has two APs affiliated with it—AP1 and AP2. The non-AP MLD has two non-AP STAs affiliated with it—STA1 and STA2. The non-AP MLD is associated with the AP MLD and has formed two links—link 1 and link 2 which constitute an NSTR link pair. As depicted, AP2 is requested to assist help STA2 that has lost medium synchronization to transmit a frame. In this example, the STA1 transmits a data frame to API and the modified AAR control subfield can be present in the data frame. The AAR control subfield is requesting for AP2's assistance to STA2's medium synchronization recovery. The bits corresponding to link 2 can be set to 1 in the link ID bitmap to indicate the link for which the assistance is being requested. The timing constraint information can be indicated in the modified AAR control subfield. Based on this information, AP2 knows the time before which STA2 must be assisted. AP2 can then send prioritize STA2 for transmission of trigger frames to solicit uplink frame transmissions after the data frame reception at API is completed. Upon receiving the trigger frame, STA2 can consider its medium synchronization recovery to be complete and transmit the uplink frame.

In another embodiment, the STA can transmit frames to provide the AP with measurement related information. This measurement related information can provide the AP with an understanding of the delay constraints on the frames that the STA intends to transmit to the AP. The AP can take the delay constraints into account when assisting the STA in medium synchronization recovery.

In one embodiment, an STA (affiliated with an MLD) that constitutes an NSTR link pair and wants to synchronize the start times with the other STA affiliated with the same MLD and part of the NSTR link pair, can perform a division of the backoff hold time into slots when counting down.

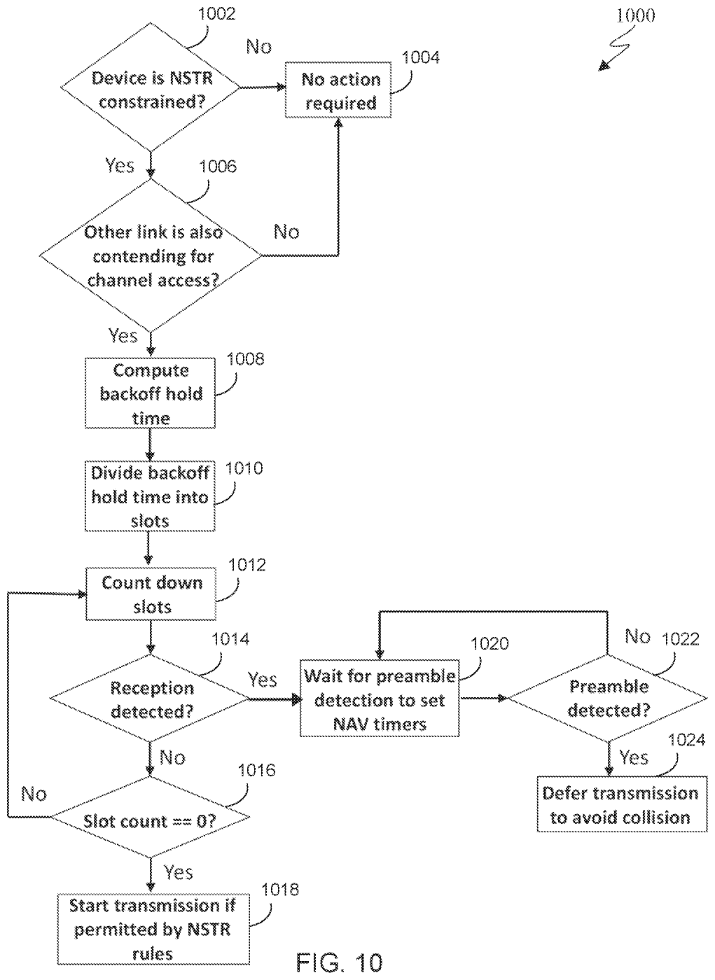

FIG. 10 illustrates a flowchart of a method 1000 performed by a STA for NSTR start time synchronization according to embodiments of the present disclosure. The embodiment of the flowchart 1000 for NSTR start time synchronization shown in FIG. 10 is for illustration only. Other embodiments of the flowchart 1000 for NSTR start time synchronization could be used without departing from the scope of this disclosure.

As illustrated in FIG. 10, the method 1000 begins at step 1002, where a determination is made whether a device is NSTR constrained. If not, then at step 1004, no action is required. If yes, then at step 1006, a determination is made whether another link is also contending for channel access. If not, then no action is required (step 1004). If yes, then at step 1008, backoff hold time is computed. At step 1010, the backoff hold time is divided into slots or time intervals. At step 1012, the slots are counted down. At step 1014, a determination is made whether reception is detected. If not, then at step 1016, a determination is made whether the slot count equals zero. If the slot count does not equal zero, the method reverts to step 1012. If the slot count equals zero, then at step 1018 transmission is started if permitted by NS TR rules. If reception is detected at step 1014, then at step 1020, the method waits for preamble detection to set NAV timers. At step 1022, a determination is made whether a preamble is detected. If not, then the method reverts to step 1020. If yes, then at step 1024, transmission is deferred to avoid collision.

As depicted in FIG. 10, when an STA that constitutes an NSTR link pair and wants to synchronize the start time of PPDU transmission with the other STA that is a part of the link pair, the STA that wants to synchronize the start time of PPDU transmission can first compute the backoff hold time. As an example, if the STA on link 1 wants to wait until the backoff on link 2 is completed, the backoff hold time can be computed as follows:

Backoff hold time=T0_{L2}−T0_{L1}

Where T0_{L1} is the time when the backoff counter of the STA on link 1 reaches zero and T0_{L2} is the time when the backoff counter of the STA on link 2 reaches zero.

Consequently, after computation of the backoff hold time, as depicted in FIG. 10, the backoff hold time can be divided into slots. Here the slot duration can be set to a value such that they are larger than the time for energy detection to complete (e.g., 9 microseconds). The significance of dividing the backoff hold time into slots whose value is higher than energy detection time is that it prevents the device from switching the state in the middle of a slot. According to one embodiment, for division of backoff into slots, the number of slots that can fit into the backoff hold time can be computed as follows.

$$Backoff hold time slot count = ceil ( \frac{b a ckoff hold time}{b a ckoff hold time slot duration} )$$

Further, according to this embodiment, the backoff hold time can be adjusted as follows.

Backoff hold time=Backoff hold time slot duration*backoff hold time slot count

This ensures that there is a sufficient period of time for energy detection to be completed and the reception state to be detected which would trigger a state change to reception thereby preventing the STA from starting a transmission that causes a collision.

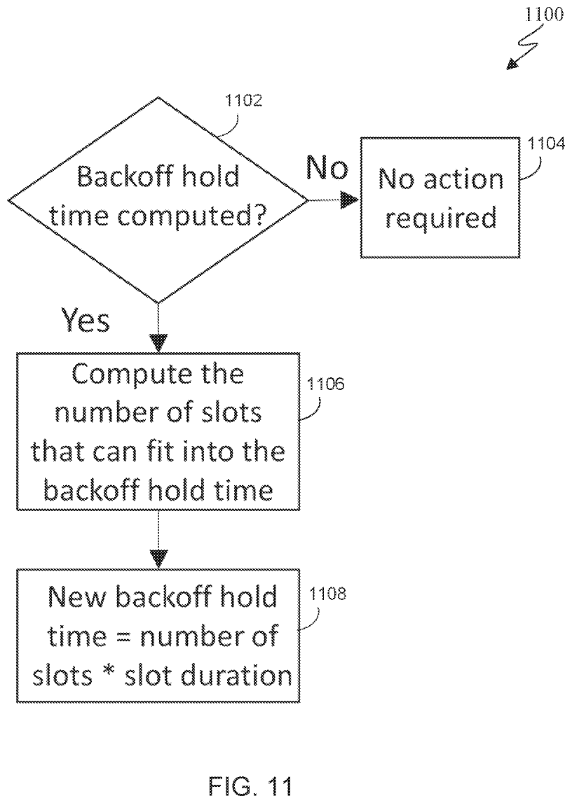

FIG. 11 illustrates a flowchart of a method 1100 for slotted backoff hold time computation according to embodiments of the present disclosure. The embodiment of the method 1100 for slotted backoff hold time computation shown in FIG. 11 is for illustration only. Other embodiments of the method 1100 for slotted backoff hold time computation could be used without departing from the scope of this disclosure.

As illustrated in FIG. 11, the method 1100 begins at step 1102, where a determination is mane whether the backoff hold time has been computed. If not, then at step 1104, no action is required. If yes, then at step 1106, the number of slots that can fit into the backoff hold time is computed. At step 1108, a new backoff hold time equals the number of slots*the slot duration.

Once the number of backoff hold time slots are computed, as depicted in FIG. 10, the device can start to count down slots. In the middle of any of the slots, if energy detection detects a reception, the STA can delay transmission and add an additional wait time until the preamble is detected. In such a scenario, the STA on the other link that constitutes an NSTR link pair and with which the STA on the first link is trying to synchronize its PPDU start time by holding its backoff counter at zero, can enter a NSTR based deferral state in which it can defer its transmission to avoid any NSTR interference to the reception of the first STA. However, if no reception is detected and the backoff hold time slot count reaches zero, then the STA can initiate data transmission if allowed by the rules of NSTR transmission in the standard.

IEEE 802.11be, allows a 4 microseconds mismatch in the PPDU transmission start times of two STAs that constitute an NSTR link pair. This value of 4 microseconds is derived from aRxTxTurnaroundTime value which is equal to 4 microseconds as well. When the backoff hold time is adjusted, this further increases the mismatch between the PPDU start times of the two links. According to one embodiment, the allowed mismatch in the PPDU transmission start time can be increased to 4+backoff hold time slot duration to account for the additional mismatch that the backoff hold time slot division can create.

In one embodiment, the backoff hold time slot duration can be a fixed value, such as a value that is mandated by the standard. In another embodiment, the backoff hold time slot duration can be determined by an individual device based on its own hardware capability and considering the amount of time it takes for performing energy detection.

In another embodiment, the backoff slot time can be a value that the AP can determine. This can be useful to maintain fairness in channel contention amongst the non-AP MLDs that have NSTR link pairs and will be using the backoff hold time slot procedure to align PPDU start times. Otherwise, some of the STAs of the non-AP MLD could gain an unfair advantage if their backoff hold time slot durations are smaller as they can count down to zero sooner in scenarios where the backoff hold times of two STAs on the same link and affiliated with different MLDs are the same.

According to this embodiment, the AP can transmit a frame to each STA to check the value of backoff hold time slot duration that the STA intends to use on a given link. The information in the frame can be as shown in Table I along with the example values of the size required to carry this information.

TABLE I
Information requested by the AP for determining
a common backoff hold time slot duration for
all STAs that constitute an NSTR link pair

| Field | Description | Size |
|---|---|---|
| Link ID | The link ID corresponding to the link for which the | 4 bits |
| | backoff hold time slot duration value is being | |
| | requested | |

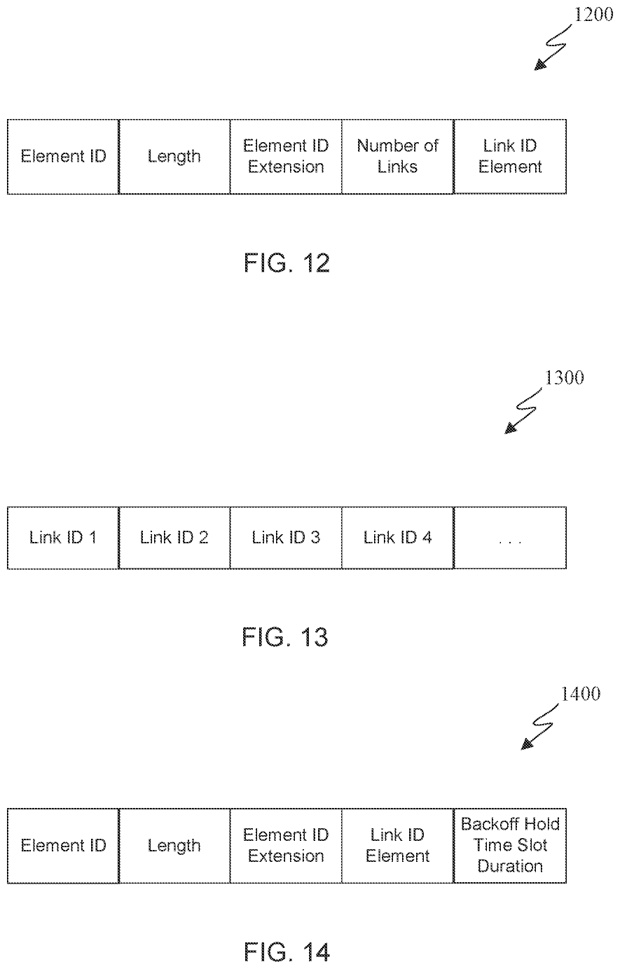

FIG. 12 illustrates an example frame format 1200 for request frame for collection of backoff hold time slot duration from the non-AP MLDs by the AP MLD according to embodiments of the present disclosure. The embodiment of the example frame format 1200 shown in FIG. 12 is for illustration only. Other embodiments of the example frame format 1200 could be used without departing from the scope of this disclosure.

As depicted in FIG. 12, the request frame contains a Link ID element. The link ID element contains link IDs corresponding to each link for which the backoff hold time slot duration is being requested by the AP.

FIG. 13 illustrates an example Link ID element 1300 for the request frame format according to embodiments of the present disclosure. The embodiment of the example Link ID element 1300 for the request frame format shown in FIG. 13 is for illustration only. Other embodiments of the example Link ID element 1300 for the request frame format could be used without departing from the scope of this disclosure.

As illustrated in FIG. 13, if the number of link IDs is an odd number, then the remaining 4 bits can be kept reserved.

Upon receiving the request frame, the non-AP MLD can transmit the request information in a response frame containing information as indicated in Table II.

TABLE II
Information transmitted by the non-AP MLD
in response to the AP's request frame

| Field | Description | Size |
|---|---|---|
| Link ID | The link ID corresponding to the link for which | 4 bits |
| | the backoff hold time slot duration value is | |
| | being requested | |
| Backoff hold | The slot duration value that the STA intends to | 1 octet |
| time slot | use for backoff hold time slot division on the | |
| duration | corresponding link | |

FIG. 14 illustrates an example frame format 1400 for a response frame transmitted by the non-AP MLD to the APMLD according to embodiments of the present disclosure. The embodiment of the example frame format 1400 for a response frame transmitted by the non-AP MLD to the APMLD shown in FIG. 14 is for illustration only. Other embodiments of the example frame format 1400 for a response frame transmitted by the non-AP MLD to the APMLD could be used without departing from the scope of this disclosure.

As illustrated in FIG. 14, similar to the request frame, the response frame can also contain a link ID element indicating the link IDs for which the information is being indicated by the non-AP MLD. Further, the response frame can also contain a backoff hold time slot duration element which contains the backoff hold time slot duration values for the link IDs indicated in the link ID element. The order for the backoff hold time slot duration values is the same as the order in which the link IDs are indicated.

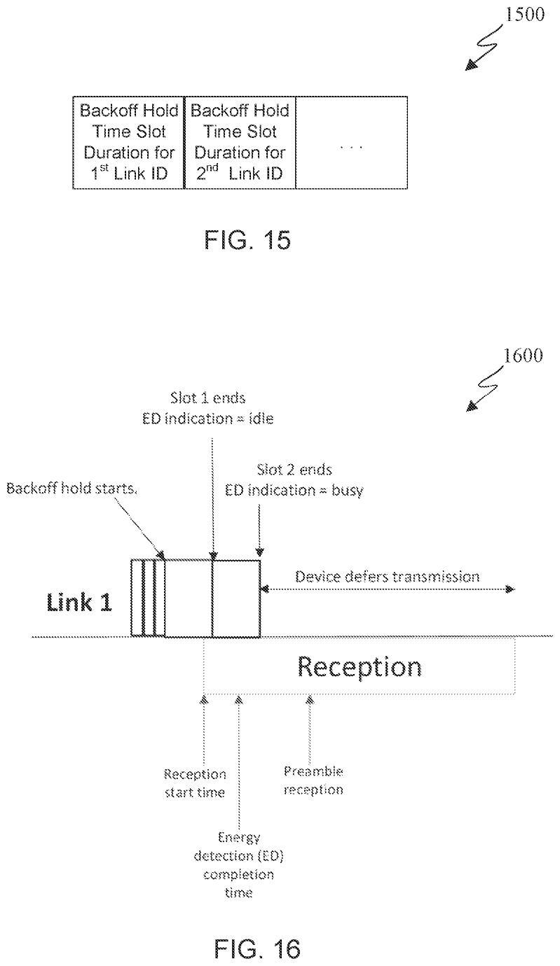

FIG. 15 illustrates an example backoff hold time slot duration element frame format 1500 according to embodiments of the present disclosure. The embodiment of the example backoff hold time slot duration element frame format 1500 shown in FIG. 15 is for illustration only. Other embodiments of the example backoff hold time slot duration element frame format 1500 could be used without departing from the scope of this disclosure.

As illustrated in FIG. 15, the backoff hold time slot duration element frame format may include the backoff hold time slot duration for the first link ID and the backoff hold time slot duration for the second link ID. Upon receiving the backoff hold time slot duration values from all the STAs, the AP can determine a suitable value and transmit that value to all the STAs in a separate frame. The frame can have the same format as the format for the response frame depicted in FIG. 14. Consequently, for each link ID indicated in the link ID element, the AP can provide a backoff hold time slot duration that the STAs on that particular link can use.

FIG. 16 illustrates an example of a slotted backoff hold time procedure 1600 according to embodiments of the present disclosure. The embodiment of the example slotted backoff hold time procedure 1600 shown in FIG. 15 is for illustration only. Other embodiments of the example slotted backoff hold time procedure 1600 could be used without departing from the scope of this disclosure.

As illustrated in FIG. 16, after application of the hold time procedure, the behavior of the STA on link 1 can be such that the problem of increased collision can be avoided. As illustrated in the example, the STA on link 1 performs a slotted backoff hold time procedure. At the end of each slot, the STA on link 1 checks the outcome of energy detection. In the example, the backoff hold time duration and the slot duration result in two slots being computed. At the end of each slot, the outcome of energy detection is checked to determine the next steps to take. At the end of slot one, as depicted in the example, energy detection is not completed. As a result, the device continues to count down slots. At the end of slot 2, the energy detection is completed and the device detects the channel as busy and defers communication thereby avoiding a collision.

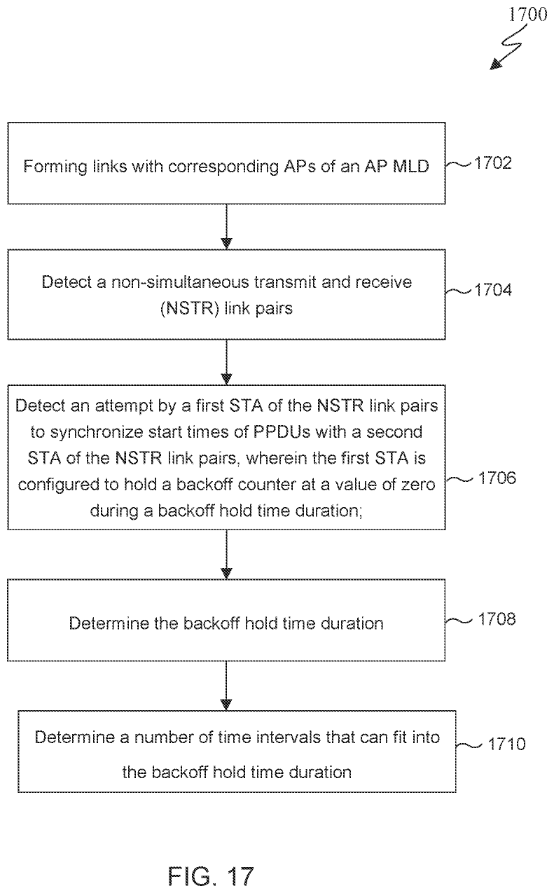

FIG. 17 illustrates a flowchart of a method 1700 for wireless communication performed by a non-AP device according to embodiments of the present disclosure. The embodiment of the method 1700 for wireless communication performed by a non-AP device shown in FIG. 17 is for illustration only. Other embodiments of the method 1700 for wireless communication performed by a non-AP device could be used without departing from the scope of this disclosure.

As illustrated in FIG. 17, the method 1700 begins at step 1702, where the non-AP MLD forms links with corresponding APs of an AP MLD. At step 1704, the non-AP MLD detects a NSTR link pairs. At step 1706, the non-AP MLD detects an attempt by a first STA of the NSTR link pairs to synchronize start times of PPDUs with a second STA of the NSTR link pairs, wherein the first STA is configured to hold a backoff counter at a value of zero during a backoff hold time duration. At step 1708, the non-AP MLD determines the backoff hold time duration. At step 1710, the non-AP MLD determines a number of time intervals that can fit into the backoff hold time duration.

In one embodiment, the non-AP MLD detects initiation of a medium synchronization loss recovery procedure; transmits information associated with timing to the AP, the information associated with timing configured to aid the AP in making a scheduling decision; and receives data associated with the information associated with timing from the AP.

In one embodiment, the non-AP MLD transmits the information associated with timing in an AP-assisted medium synchronization recovery (AAR) control subfield.

In one embodiment, the information associated with timing comprises measurement information associated with delay constraints on frames that the first STA intends to transmit to the AP.

In one embodiment, the non-AP MLD determines the backoff hold time duration T0L2−T0L1, wherein T0L1 is a duration when the backoff counter of the first STA reaches zero, T0L2 is a duration when a backoff counter of the second STA reaches zero, and T0L2>T0L1.

In one embodiment, a duration of each of the time intervals is greater than a duration for energy detection to complete, and the number of time intervals that can fit into the backoff hold time duration=ceil (the backoff hold time duration/the duration of each of the time intervals), wherein ceil is a ceiling function.

In one embodiment, the non-AP MLD counts down the number of time intervals by a value of one; detects that energy detection indicates an idle channel; and continues to a next time interval.

In one embodiment, the non-AP MLD adjusts the backoff hold time duration, wherein the adjusted backoff hold time duration=the duration of each of the time intervals*the number of time intervals that can fit into the backoff hold time duration.

In one embodiment, the duration of each of the time intervals is a fixed value.

In one embodiment, the non-AP MLD 2 determines the duration of time of each of the time intervals; and transmits the duration of time of each of the time intervals.

The above flowcharts illustrate example methods that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A non-access point (AP) multi-link device (MLD) comprising:
stations (STAs) each comprising a transceiver configured to form a link with a corresponding AP of an AP MLD; and
a processor operably coupled to the STAs, the processor configured to:
detect a non-simultaneous transmit and receive (NSTR) link pairs;
detect an attempt by a first STA of the NSTR link pairs to synchronize start times of physical layer protocol data units (PPDUs) with a second STA of the NSTR link pairs, wherein the first STA is configured to hold a backoff counter at a value of zero during a. backoff hold time duration;
determine the backoff hold time duration; and
determine a number of time intervals that can fit into the backoff hold time duration.

2. The non-AP MLD of claim 1, wherein:
the processor is further configured to detect initiation of a medium synchronization loss recovery procedure, and
the transceiver is further configured to:
transmit information associated with timing to the AP, the information associated with timing configured to aid the AP in making a scheduling decision, and
receive data associated with the information associated with timing from the AP.

3. The non-AP MLD of claim 2, wherein the transceiver is configured to transmit the information associated with timing in an AP-assisted medium synchronization recovery (AAR) control subfield.

4. The non-AP MLD of claim 2, wherein the information associated with timing comprises measurement information associated with delay constraints on frames that the first STA intends to transmit to the AP.

5. The non-AP MLD of claim 1, wherein to determine the backoff hold time duration, the processor is configured to determine T0_{L1} and T0_{L2}, wherein:
T0_{L1} is a duration when the backoff counter of the first STA reaches zero,
T0_{L2} is a duration when a backoff counter of the second STA reaches zero,
T0_{L2}>T0_{L1}, and
the backoff hold time=T0_{L2}−T0_{L1}.

6. The non-AP MLD of claim 1, wherein:
a duration of each of the time intervals is greater than a duration for energy detection to complete, and
the number of time intervals that can fit into the backoff hold time duration=ceil (the backoff hold time duration/the duration of each of the time intervals), wherein ceil is a ceiling function.

7. The non-AP MLD of claim 6, wherein the processor is further configured to:
count down the number of time intervals by a value of one,
detect that energy detection indicates an idle channel, and
continue to a next time interval.

8. The non-AP MLD of claim 6, wherein the processor is further configured to adjust the backoff hold time duration, wherein the adjusted backoff hold time duration=the duration of each of the time intervals*the number of time intervals that can fit into the backoff hold time duration.

9. The non-AP MLD of claim 6, wherein the duration of each of the time intervals is a fixed value.

10. The non-AP MLD of claim 6, wherein:
the processor is configured to determine the duration of time of each of the time intervals, and
the transceiver is configured to transmit the duration of time of each of the time intervals.

11. A method for wireless communication performed by a non-access point (AP) multi-link device (MLD) that comprises stations (STAs), the method comprising:
forming links with corresponding APs of an AP MLD;
detecting a non-simultaneous transmit and receive (NSTR) link pairs;
detecting an attempt by a first STA of the NSTR link pairs to synchronize start times of physical layer protocol data units (PPDUs) with a second STA of the NSTR link pairs, wherein the first STA is configured to hold a backoff counter at a value of zero during a backoff hold time duration;
determining the backoff hold time duration; and
determining a number of time intervals that can fit into the backoff hold time duration.

12. The method of claim 11, further comprising:
detecting initiation of a medium synchronization loss recovery procedure;
transmitting information associated with timing to the AP, the information associated with timing configured to aid the AP in making a scheduling decision; and
receiving data associated with the information associated with timing from the AP.

13. The method of claim 12, further comprising transmitting the information associated with timing in an AP-assisted medium synchronization recovery (AAR) control subfield.

14. The method of claim 12, wherein the information associated with timing comprises measurement information associated with delay constraints on frames that the first STA intends to transmit to the AP.

15. The method of claim 11, wherein:
determining the backoff hold time duration comprises determining T0L1 and T0L2,
T0L1 is a duration when the backoff counter of the first STA reaches zero,
T0L2 is a duration when a backoff counter of the second STA reaches zero,
T0L2>T0L1, and
the backoff hold time duration=T0L2−T0L1.

16. The method of claim 11, wherein:
a duration of each of the time intervals is greater than a duration for energy detection to complete, and
the number of time intervals that can fit into the backoff hold time duration=ceil (the backoff hold time duration/the duration of each of the time intervals), wherein ceil is a ceiling function.

17. The method of claim 16, further comprising:
counting down the number of time intervals by a value of one;
detecting that energy detection indicates an idle channel; and
continuing to a next time interval.

18. The method of claim 16, further comprising adjusting the backoff hold time duration, wherein the adjusted backoff hold time duration=the duration of each of the time intervals*the number of time intervals that can fit into the backoff hold time duration.

19. The method of claim 16, wherein the duration of each of the time intervals is a fixed value.

20. The method of claim 16, further comprising:
determining the duration of time of each of the time intervals; and
transmitting the duration of time of each of the time intervals.
